(19) United States
(12) Patent Application Publication
(10) Pub. No.: US 2026/0121793 A1
(43) Pub. Date: Apr. 30, 2026

(54) METHOD AND SYSTEM FOR CALCULATING FORWARD ERROR CORRECTION WITH A REDUCED NUMBER OF GATES IN FEC ENCODERS

(71) Applicant: INOVA SEMICONDUCTORS GMBH, Munich (DE)

(72) Inventors: Fabian KLUGE, Perasdorf (DE); Roland NEUMANN, Bad Toelz (DE)

(73) Assignee: INOVA SEMICONDUCTORS GMBH, Munich (DE)

(21) Appl. No.: 19/425,570

(22) Filed: Dec. 18, 2025

Related U.S. Application Data
(63) Continuation of application No. PCT/EP2024/055989, filed on Mar. 7, 2024.

(30) Foreign Application Priority Data
Jun. 21, 2023 (EP) 23180789.2

(51) Int. Cl. H04L 1/00

(52) U.S. Cl. CPC H04L 1/0057

(57) ABSTRACT

A method for improving forward error correction in serial coding during data transmission in a vehicle offers an advantage that the physical behavior on a transmission channel can be deterministically controlled despite a reduction in resource requirements. A number of gates in the forward error correction encoders is reduced by using preliminary calculations of the forward error correction on individual subwords to minimize exponential growth in a number of gates required. Bit errors are minimal and a transmission error can be corrected efficiently. Encoders used are designed with a minimal number of gates, and the proposed method implicitly includes nesting that allows so-called burst errors to be corrected advantageously. This nesting makes it possible to eliminate conventional buffer memory required by explicit nesting. The method further ensures that user data and corrective metadata, can be encoded for advantageous transmission. Also provided is a system for implementing the method.

### CROSS REFERENCE TO RELATED APPLICATIONS

This application is a continuation of International Application No. PCT/EP2024/055989, filed on Mar. 7, 2024, which takes priority from European Application No. 23180789.2 filed on Jun. 21, 2023 the entire contents of each of which are incorporated by reference herein.

### TECHNICAL FIELD

The present invention is directed to a method for improving forward error correction in serial coding for data transmission in a vehicle and, compared with the prior art, creates the advantage, among other things, that the physical behavior on a transmission channel can always be deterministically controlled despite a reduction in the resource requirement. The proposed method reduces the number of gates in the forward error correction encoders by minimizing the exponential growth of the number of required gates compared to the state of the art by calculating the forward error correction on individual subwords. According to the proposed method, the bit errors are minimal and a transmission error can be corrected efficiently, i.e. with minimal technical effort. In addition, the encoders used are designed with a minimum number of gates and an interleaving is implicit in the proposed method, which is based on the fact that so-called burst errors can be corrected particularly advantageously. This implicit interleaving makes it possible to dispense with the conventional buffer memory required for explicit interleaving. In addition, the invention ensures that user data together with correcting metadata can be encoded advantageously with regard to transmission. According to the invention, it can be ensured that not only the user data is line-coded or line-encoded, but also the correction data. The present invention is also directed to an analogously designed system arrangement for carrying out the method and to a computer program product with control commands which carry out the method.

### BACKGROUND

U.S. Pat. No. 7,103,830 B1 shows the division of words into sub-words with subsequent encoding.

U.S. Pat. No. 5,687,181 A shows a data transmission unit and, in particular, a data transmission unit that is used to connect units or circuit boards, for example in a computer or in interfaces of transmission systems or switching systems.

Boye Jeffrey et al: ‘11b/14b Encoding—A Fault Tolerant, DC-Balanced Line Code for AC-Coupled Channel Link Transceivers’, 2019 IEEE Aerospace Conference, IEEE, 2 Mar. 2019, shows a fault-tolerant, DC-balanced line coding scheme for use with AC-coupled channel link transceivers that have a 7-bit frame alignment as opposed to a more typical 8-bit alignment.

Various versions of the Ethernet protocol are known from the prior art. Ethernet uses a variety of techniques to detect and correct errors during data transmission. The error correction mechanisms are part of the Ethernet protocol and ensure that the data received is correct and complete. Cyclic Redundancy Check (CRC) is one of the most important error detection techniques in Ethernet. With CRC, a checksum is calculated for the data sent and attached to the packet. At the receiver, the checksum is calculated again and compared with the checksum received. If the checksums do not match, an error is detected and the packet is discarded.

Forward error correction is also known from the state of the art. Forward Error Correction (FEC) is a method of error correction in which additional redundancy information is added to the data. This redundancy allows the receiver to detect and correct errors without having to retransmit the packet. FEC is often used in high-speed Ethernet connections such as 10 Gigabit Ethernet (10 GbE) to ensure data integrity.

Link-level error correction is also known from the state of the art. Ethernet can also perform error correction at the physical level. Techniques such as signal amplification, noise suppression and error correction codes are used here to improve the stability of data transmission. These error correction mechanisms are implemented in the Ethernet transceivers that perform the conversion between digital data and physical signals.

Error correction mechanisms play a crucial role in ensuring reliable data transmission in networks. They help to detect, isolate and correct transmission errors to ensure that data integrity is maintained. Especially in mission-critical environments where large amounts of data are transmitted, error correction mechanisms are essential to maintain the quality of the connection.

In addition, the DisplayPort standard is well known. DisplayPort uses various error detection and correction methods to ensure that the transmitted data is reproduced accurately and without loss. These mechanisms are part of the DisplayPort protocol and contribute to the stability and quality of data transmission. Forward Error Correction (FEC) is an important error correction method for DisplayPort. Additional redundancy information is inserted into the transmitted data. This redundancy enables the receiver to recognize and correct erroneous data bits. In this way, errors that occur during transmission can be effectively corrected without having to resend the data.

Furthermore, it is generally known from the prior art that data transmission via a serial data channel is typically subject to errors. To counter this problem, the state of the art recognizes different encodings, such as line coding. This is also known as line coding.

The state of the art recognizes the problem of faulty data transmission via a serial communication link and provides for the line-coded data to be provided with a forward error correction. The state of the art therefore addresses the problem of error correction by providing line-coded data with a non-line-coded addition, namely forward error correction, which in turn is not line-coded. Thus, in the state of the art there is the problem that even if line coding is provided, individual metadata is not transmitted in coded form and therefore the advantages of line coding cannot be used for all transmitted data. This in turn represents a source of error. The state of the art sometimes makes do by encoding the forward error correction data separately and then transmitting it. This results in additional work and a new forward error correction would have to be calculated in order to secure the line-coded forward error correction data. This in turn creates additional effort and also creates a non-line-coded forward error correction.

In addition, the state of the art has the problem that the forward error correction is always calculated over entire data words, so that an enormous technical effort is required to maintain and operate an exponentially growing number of gates with regard to an increasing word length. As a result, the state-of-the-art encoders that calculate the forward error correction are extremely expensive to manufacture and are also more prone to errors. In addition, they consume large amounts of energy, which is not desirable in vehicles. Errors relating to an entire word also propagate more than if error corrections were formed using partial words, which in turn leads to increased susceptibility to errors. This is also undesirable in the vehicle, as data transmission is safety-critical, especially in the vehicle. The susceptibility to errors is therefore particularly significant in an automobile or a vehicle in general, as safety-critical functions have to be provided.

Various coding methods and data transmission methods are known from the state of the art, but all of them relate to application scenarios that can only be used to disadvantage in an automobile. For example, the state of the art often assumes that high computing power is available and that there are no high real-time requirements. In addition, the state of the art often assumes that the weight or reliability of the components to be used plays a subordinate role. The state of the art often refers to conventional computer networks, where reliability and low technical complexity are less important.

Based on this state of the art, there is a need to create a method or a system arrangement which enables data to be processed as quickly as possible due to the safety requirements in the automobile and which also requires little technical effort and minimizes the error rate during transmission, as retransmission is not possible if an error is detected. The low technical effort should consist of installing components that are as simple as possible, have a low weight and can also be produced efficiently in large quantities. Known methods and system arrangements from computer network technology cannot typically be used here, as weight savings and real-time running behavior are not decisive for a stand-alone PC or server. Although the heat to be dissipated generally poses a challenge for computer arrangements, energy efficiency in an automobile is of even greater importance, as in electromobility, for example, power consumption even influences the range of the automobile.

Further state of the art relates to the transmission of data in a serial data stream. For example, the state of the art provides for extensive description data to be sent along with the user data, indicating where the user data is located and how it is to be interpreted. In addition, it is known in the state of the art to discard individual data packets if they are not transmitted correctly. It is also known in the state of the art to resend data packets if they do not arrive at a sender on time or in an unexpected format.

In the serial transmission of data, it is necessary to have as many ones and zeros as possible in the serial data stream. This is called disparity. A disparity of zero on average and also over a short period of time is desirable to avoid baseline drift during transmission. The baseline drift (DC voltage fluctuation) of the serial signal leads to bit errors. In extreme cases, transmission is not possible.

A minimum number of 0->1 or 1->0 transitions is required to be able to reliably recover the serial bits in the serial data stream on the receiving side without the need to transmit a clock. This means that the clock for recovering the serial data is generated locally at the receiver from the serial data stream. The so-called run length specifies how many identical bits (ones or zeros) can occur in succession without changing. A short run length is always desirable, as long run lengths no longer allow the clock to be reliably recovered from the serial data stream.

The task of the line code (in this case a block code or line code) is now to generate a symbol with guaranteed disparity and guaranteed run length from any data words with any disparity and infinite run length. This leads to an overhead during transmission. This means that more bits (in the form of symbols) have to be transmitted than occur in the net data word to be transmitted. This means that the required transmission speed (bandwidth) must be greater than the data rate of the data to be transmitted. This in turn means that systems require higher error rates or more effort, power, etc. than would be necessary to transmit the raw data.

It is therefore a task of the present invention to propose a method for improving forward error correction in serial coding during data transmission in a vehicle. The proposed method should be efficient, require little technical effort and be as error robust as possible. Furthermore, it is a task of the present invention to provide an appropriately equipped system arrangement for carrying out the method. Furthermore, it is a task of the present invention to propose a computer program product which provides control commands which implement the method or operate the system arrangement. In addition, a storage medium with control commands is to be proposed.

### SUMMARY

The problem may be solved in accordance with this disclosure.

Accordingly, a method for calculating a forward error correction with a reduced number of gates in FEC encoders is proposed, comprising a decomposition of a data word into a sequence of data subwords according to a provided data structure; decomposing further data words into data subwords of the data structure, wherein a position index is assigned to each position of the data subwords within the sequence; concatenating all data subwords of the same position index into a data subword block; and calculating a data subword block forward error correction over each data subword block, in such a way that its data subwords are treated together, whereby a line code segment is generated for each data subword block and/or each data subword block forward error correction.

In a preparatory process step, a serial data stream is optionally provided. This is user data or raw data which is to be transmitted from a receiver to a transmitter. As the communication channel is potentially error-prone, a forward error correction is to be carried out, for which corresponding forward error correction encoders are required, also known as FEC encoders. In order to transmit the raw data, it is divided into individual data words of the same length.

A data word is then broken down into a sequence of data sub-words, also known as segments, according to a provided data structure. The data structure can be a subdivision rule that specifies how many bits the individual data subwords comprise. Particularly preferably, the data structure takes into account the available encoders. According to embodiments of the invention, two types of encoder can be used. These are the forward error correction coders and the line coders. The so-called FEC encoders are those computing units which calculate a forward error correction for an input signal or a data subword or segment. In accordance with embodiments of the invention, all data to be transmitted is line-encoded, for which purpose corresponding specialized line encoders are provided. If the line encoders are specialized to a certain bit length, the data structure or the subdivision rule is selected accordingly. For example, individual line encoders encode 6 bits to 8 bits, which in turn means that the data structure is selected accordingly and the segments or data subwords are 6 bits long. In this case, the data subwords do not generally have to be the same length, although they are the same length with regard to the data words. This means that the data structure is the same for all data words, whereby this determines the same bit length of the data subwords for each position. For example, if the data structure specifies that a first data subword is 6 bits, a second data subword is 8 bits and a third data subword is 6 bits, this division or data structure is the same for all data words. However, the example illustrates that the individual segments can be of different lengths. This does not exclude the possibility that data subwords of the same bit length may also be present. The data structure is therefore based on the line encoders, which then process data subwords of exactly the length for which they are optimized. This has the technical effect that the line encoder can be minimally equipped with regard to the coding and thus the gates to be used.

According to embodiments of the invention, further data words are broken down into data subwords of the data structure, with each position of the data subwords being assigned a position index within the sequence. In total, a serial data stream can therefore consist of data words, which in turn are broken down into data subwords. These data sub-words are segments that are recognized in all the data words provided and are assigned a position index. This position index reflects the order of the respective data subword. As all data words are divided equally into data sub-words, the respective position indices are the same. Figuratively speaking, the data words can be arranged one below the other, with the data subwords representing columns of the data words. The columns have a uniform width, which corresponds to the corresponding data subword. The position index does not have to be assigned explicitly, but can be assigned implicitly by the decomposition.

According to embodiments of the invention, all data subwords with the same position index are concatenated to form a data subword block. Concatenation in this case means merging. The concatenation can be illustrated in such a way that the data subwords are arranged one below the other and the data subwords form columns so that each data subword is appended to the upper data subword, as shown in the figures, for example. Figuratively speaking, the data subword blocks correspond to the individual columns. Concatenation, i.e. logical merging, is not necessarily an explicit merging, but all data subwords are implicitly treated together in the same position. This means that there does not necessarily have to be an explicit concatenation step, but rather an implicit concatenation, i.e. a merging in the sense that these data subword blocks are treated together in further process steps. The number of data subword blocks corresponds to the number of data subwords or segments. These are treated equally column by column.

A data subword block forward error correction is then calculated for each data subword block. This therefore means that the individual columns are treated separately and a separate forward error correction is calculated for each column-wise segment or data subword.

In subsequent process steps, this calculated forward error correction can be line-coded together with the data subwords, which in turn produces a line code for each data subword block. This line code then refers to the data subword block together with the data subword block forward error correction. This is carried out for all columns or segments and therefore a corresponding line code is output for all data words, which already contains the forward error correction.

The data encoded in this way can then be transmitted via the potentially faulty line.

Further process steps can be provided for this purpose and, in particular, it is provided according to embodiments of the invention that the process steps are carried out inversely on the receiver side, so that the error-corrected data words can ultimately be viewed at the receiver.

According to embodiments of the invention, the forward error correction is improved by the fact that it is calculated with respect to user data and that the user data is first segmented for this purpose. A separate forward error correction is then calculated for each segment, so that the forward error correction does not relate to an entire data word, but to different subwords. This keeps the number of gates of the FEC coders to be used low and avoids exponential growth. In addition, an improvement results from the fact that, according to embodiments of the invention, a line coding is carried out via the user data together with the forward error correction, thus overcoming the disadvantage in the prior art that the forward error correction is transmitted in a non-coded form.

Furthermore, it is advantageous that the error correction can work more efficiently, since the error correction only refers to partial words and can therefore recognize in fine granularity where an error has occurred. Conventional error corrections always refer to entire data words and are therefore inefficient or errors can occur in the prior art that cannot be corrected. This is avoided by the segmentation according to embodiments of the invention.

A further improvement is that all transmitted data is line coded and thus the entirety of the data can benefit from the line coding. The transmission link can thus be deterministically controlled and the bit errors are kept to a minimum. In addition, implicit interleaving results from the fact that smaller packets are sent and thus implicit interleaving occurs, as not all of the data words are transmitted. This is achieved by using several forward error correction encoders, each of which refers only to partial words. Thus, according to embodiments of the invention, the disadvantage in the prior art of having to create an explicit interleaving at great expense, which would also require additional buffer memories, is overcome.

Due to the optimized disparity (line coding) of the bit sequence to be transmitted, it is possible to avoid errors when interpreting on a serial channel. Efficiency therefore also refers to the fact that the bit sequence is particularly error-resistant and can therefore only be reliably transmitted once. Redundant transmission is avoided due to the high detectability, again due to the optimized disparity.

When transmitting data serially, it is advantageous to keep the number of ones and zeros in the serial data stream as equal as possible. This is generally referred to as disparity. For reliable clock recovery at the receiver, a run length restriction can be imposed on the generated channel sequence. This limits the maximum number of consecutive ones and zeros. Thus, the proposed method can also be described as a method for efficient coding of a bit sequence. According to embodiments of the invention, the disparity is optimized by cleverly setting partial disparities. This can be used particularly advantageously if the run length of the bit sequence is limited. The restricted disparity and the restricted run length can also relate to the arbitrary bit sequence provided. This means that it does not have to be the efficiently transferable bit sequence. Overall, the arbitrary bit sequence provided can be transmitted efficiently or a bit sequence to be transmitted is generated or created from this bit sequence, which can then be transmitted efficiently.

The proposed method can be used specifically in the vehicle or is specially tailored to the requirements in the vehicle. This is the case because safety-critical functions are offered in the vehicle, which must be protected accordingly. According to embodiments of the invention, this is done in several ways. On the one hand, through forward error correction and via line coding. In addition, the reduced number of gates required is particularly advantageous in electromobility.

According to one aspect of the present invention, a line code segment is generated for each data subword block and/or each data subword block forward error correction. This has the advantage that the forward error correction in particular does not have to be transmitted in uncoded form, but is instead also line-coded. Thus, the advantages of line coding are not only available for the user data but also for the forward error correction.

According to a further aspect of the present invention, a forward error correction for a data block is composed of several partial forward error corrections of the data subword blocks. This has the advantage that not an entire forward error correction is initially generated, but many individual partial forward error corrections, which in their entirety form an overall forward error correction. In this way, the number of gates of the required FEC encoders is kept to a minimum. Nevertheless, it is possible to protect all data by means of a forward error correction and, in addition, to transmit the data together with the forward error correction FEC in line coded form.

According to a further aspect of the present invention, the data structure is read out and a forward error correction sub-encoder is selected depending on the respective bit lengths of the data sub-words. This has the advantage that the FEC encoders are precisely tailored to the segment lengths or the bit lengths of the subwords. In this way, it is possible to minimize the number of gates in such a way that the encoders only have to create encodings for small subwords and not for the entire data words. Consequently, each FEC encoder is precisely tailored to the bit length of the data subword to be encoded.

According to a further aspect of the present invention, the number of gates of the FEC partial encoders is selected as a function of a bit length of the data subwords. This has the advantage that, compared to the prior art, the number of gates required in the FEC coders is reduced and thus an efficient system arrangement or an efficient method is created, which is particularly advantageous in the automobile or in the vehicle. In this way, no gates need to be provided that would not be necessary. This results in a deterministic and minimal number of gates.

According to a further aspect of the present invention, the number of all gates of all encoders is selected in such a way that a linear increase in the number of gates with respect to increasing data word lengths results from iterative execution of the method. This has the advantage that a minimum number of gates is provided, taking into account the data format, or that the data format can be selected in such a way that only a linear increase in the number of gates is necessary. For example, in one embodiment, the maximum bit length can be 10, 11 or 12 bits, which means that the required gates or circuits of the FEC encoder only increase linearly. Since an exponential growth of gates is necessary for larger values, embodiments of the present invention create the technical effect that the power consumption or energy consumption is minimized, which in turn leads to less waste heat. In addition, the proposed method is particularly robust, which is particularly advantageous in automobiles, as safety-critical functions are offered here.

According to a further aspect of the present invention, each data word has 112 bits. This has the advantage that words of 128 bits can be created with line coding, which corresponds to a common format. According to embodiments of the invention, it has been shown that 112 bits in particular can be encoded robustly 128 bits. This ensures that the transmission is subject to a lossy or error-prone data channel.

According to a further aspect of the present invention, the bit length of the data subword block forward error correction is selected such that it corresponds to the bit length of the data subwords. This has the advantage that both the forward error correction and the data subwords or segments can be encoded using the same encoder, which is the line encoder, i.e. not the FEC encoder. Thus, embodiments of the present invention make the technical contribution that not only a minimum number of gates must be provided, but also the total number of encoders is minimized. Thus, the forward error correction can be line coded with the same encoder as the actual segments of the user data.

According to a further aspect of the present invention, the data subword block forward error correction and the data subword block on the basis of which the data subword block forward error correction is calculated are line-encoded using the same line encoder. This has the advantage that a minimum number of line encodings must be provided. Figuratively speaking, virtually all columns, i.e. all partial word blocks together with the corresponding partial forward error correction, are line-encoded with the same segment encoder in each case.

According to a further aspect of the present invention, the data structure is selected as a function of the bit length of the data words. This has the advantage that the different bit lengths can also be dealt with dynamically at runtime and thus the same data format can be selected for further data words as for a first data word provided. If first data words are available, a corresponding data structure can be used for a further serial data stream and the further data words are structured in such a way that they correspond to the data structures of the data words received first.

According to a further aspect of the present invention, serial line coding is performed after the data subword block forward error correction has been calculated. This has the advantage that the order as provided in the prior art is reversed and the forward error correction is calculated first, which means that it can also be line coded and does not have to be transmitted unencrypted or uncoded.

According to a further aspect of the present invention, the method steps are performed in a virtualized manner and information about the underlying encoders and/or gates is generated. This has the advantage that the embodiments can be evaluated in a preparatory process step and in this respect it can be determined how many gates or how many FEC encoders and/or line encoders are to be provided. In addition, the process as a whole can be simulated. Hardware components can be provided virtually.

According to one aspect of the present invention, the subdivision rule is stored in a data memory and is available as a coding rule and/or is read out from a hardware architecture. This has the advantage that the subdivision rule can be statically predetermined or can also be changed in the data memory. In addition, the subdivision rule can take the corresponding hardware architecture into account. If, for example, different encoders are provided for different bit lengths, the bit sequences can be subdivided in such a way that the corresponding segments correspond to the respective encoders. The segments therefore have exactly the length provided by the respective encoder.

According to a further aspect of the present invention, all bit sequences have the same structure in their data format, have the same segment lengths and/or the same bit positions. This has the advantage that the individual segments can be fed to the respective encoders. For example, each first segment of each bit sequence is fed to the same encoder. Thus, figuratively speaking, the segments can be encoded column by column and there is a specialized encoder for each column.

According to a further aspect of the present invention, the partial forward error correction has correction information which describes a target content of the segment over which the partial forward error correction was created. This has the advantage that the transmitted data can be corrected by means of this correction data, whereby an entire correction is not formed for each bit sequence, but rather individual partial forward error corrections are formed for the individual segments. All partial forward error corrections in their entirety describe all segments of all bit sequences and therefore all user data. The difference to the state of the art here, however, is that a forward error correction is not formed for each bit sequence, but for all segments across all bit sequences. This makes it possible to use the same line encoder for each partial forward error correction that is used for the corresponding segments.

According to a further aspect of the present invention, the partial forward error correction has the same bit length as the segment over which it is created. This has the advantage that specialized line encoders can be provided and thus maximum efficiency is achieved in that the corresponding column-wise line encoders are specialized precisely for the bit length that they then also have to encode. Thus, an efficient and technically minimally complex method is created.

According to a further aspect of the present invention, an entirety of the partial forward error corrections describes all user data to be transmitted in a correctable manner. This has the advantage that all user data which are transmitted can be corrected with regard to their errors, but the individual segments can be taken into account, so that the proposed method is more finely granular than the prior art provides for.

According to a further aspect of the present invention, the segment encoders each generate at least part of a line code. This has the advantage that the outputs of the segment encoders can be combined and then provide the line codes to be transmitted.

According to a further aspect of the present invention, the set of segment encoders encodes bit sequences of 112 bits into words of 128 bits. This has the advantage that a particularly efficient line code is created.

According to a further aspect of the present invention, the partial forward error correction line codes are appended to the segment line codes during transmission. This has the advantage that all data to be transmitted is line coded and thus the line is operated deterministically or the advantages of line coding can be utilized for all data and not only for the payload data per se.

According to a further aspect of the present invention, the bit position is specified as an offset or as a bit index in the bit sequence. This has the advantage that different types of addressing can be used and the index is based on a sequence of the respective segments, which can then be advantageously specified using known methods.

According to a further aspect of the present invention, the user data is available as a serial data stream. This has the advantage that theoretically any amount of user data can be transmitted, which is then divided into bit sequences of the same length.

According to a further aspect of the present invention, the method steps are carried out in the described sequence and/or are carried out iteratively. This has the advantage that the coding sequence is reversed. According to embodiments of the invention, it is provided that the forward error correction is created first and then the line coding is performed. This does not exclude the possibility that individual process steps have to be carried out several times. This may be the case, for example, if several bit sequences are present and these need to be segmented.

The task is also solved by a system arrangement for calculating a forward error correction with a reduced number of gates in FEC coders, having a decomposition unit set up for decomposing a data word into a sequence of data subwords in accordance with a provided data structure; a further decomposition unit arranged to decompose further data words into data subwords of the data structure, wherein a position index is assigned to each position of the data subwords within the sequence ; a grouping unit arranged to concatenate all data subwords of the same position index into a data subword block; and a calculation unit arranged to calculate a data subword block forward error correction over each data subword block, in such a way that its data subwords are treated together, whereby a line code segment is generated for each data subword block and/or each data subword block forward error correction.

Also provided is a system arrangement or method which receives and then decodes the data and reads out both the forward error correction and the useful data.

The problem is also solved by a computer program product with control instructions which implement the proposed method or operate the proposed device.

According to embodiments of the invention, it is particularly advantageous that the method can be used to operate the proposed devices and units. Furthermore, the proposed devices and units are suitable for implementing the method according to embodiments of the invention. Thus, in each case the device implements structural features which are suitable for carrying out the corresponding method. However, the structural features can also be designed as method steps. The proposed method also provides steps for implementing the function of the structural features. In addition, physical components can also be provided virtually or virtualized.

### BRIEF DESCRIPTION OF THE DRAWINGS

Further advantages, features and details of the invention are provided in the following description, in which aspects of the invention are described in detail with reference to the drawings. The features mentioned in the claims and in the description may each be essential to the invention individually or in any combination. Likewise, the above-mentioned features and the features further described herein may be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are exemplary in nature for the purpose of explaining the invention. The detailed description is for the information of the person skilled in the art, therefore known circuits, structures and methods are not shown or explained in detail in the description so as not to make the present description more difficult to understand. The figures show:

FIGS. 1A-C illustrating several examples of a process sequence with serial coding and calculation of a forward error correction according to the state of the art;

FIG. 2 illustrating an optimized process flow with forward error correction and serial encoding according to an aspect of the present invention;

FIG. 3 illustrating an encoding of user data and a calculation of a forward error correction according to the prior art;

FIG. 4 illustrating a method for improving forward error correction in serial encoding in an in-vehicle data transmission according to the present invention;

FIG. 5 showing a comparison of the prior art coding and the method for improving forward error correction according to an aspect of the present invention;

FIG. 6 providing a diagram illustrating the required number of gates per bit length of forward error corrections;

FIG. 7A showing an encoding of user data into a line code according to an aspect of the present invention;

FIG. 7B showing the proposed system arrangement for improving forward error correction in serial coding in an in-vehicle data transmission according to an aspect of the present invention;

FIG. 8A showing an aspect of the method for improving forward error correction according to an aspect of the present invention at the transmitter side;

FIG. 8B showing a method for improving forward error correction on the receiver side according to an aspect of the present invention; and

FIG. 9 providing a flowchart of a method for improving forward error correction in serial coding in a data transmission according to an aspect of the present invention.

### DETAILED DESCRIPTION

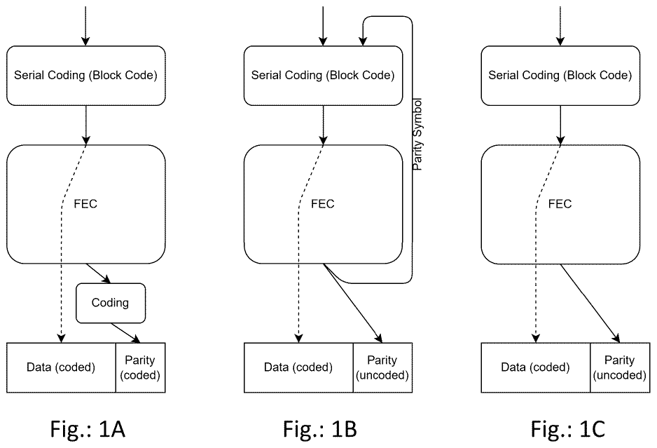

FIGS. 1A-C show three examples of how forward error correction is performed according to conventional methods. On the left-hand side, an example is shown which first performs serial coding of the user data and then generates a forward error correction code FEC. The serially encoded data is transmitted and the forward error correction is subsequently encoded and then appended to the encoded user data. Thus, according to this example from the state of the art, the forward error correction is generated via a complete data word and this must then be encoded again and is appended. It is therefore not coded via the individual segments, but via the bit sequence as a whole.

The center shows another prior art example in which the line coding step of the forward error correction is omitted and non-encoded parity information is appended. The disadvantage here is that the last data part, i.e. the parity information, is not line-coded and is therefore highly error-prone.

The right-hand side shows an example which, in contrast to the example in the middle, does not loop back the parity information for serial coding. This has the same disadvantages as the example in the middle.

Data transmission solutions always place stricter requirements on freedom from errors/error tolerance, which require fine tuning between serial coding and forward error correction (FEC) as data rates continue to increase.

The current state of the art (Ethernet/DisplayPort) processes the data stream in the following sequence:
1. The input data is encoded in the first step using serial encoding (8b10b, 64b66b, 128b132b etc.). For larger encodings from 64b66b upwards, this is primarily achieved by scrambling using LFSR.
2. The serial coded stream is now additionally protected against bit errors by means of FEC (Forward Error Correction) coding. A complete FEC coding (FEC coding word) contains both the input data on a symbol basis as well as the so-called parity symbols. For these applications, the input data is passed through the FEC untouched. This means that they always correspond to the original serial code. There are now the following further procedures:
   a. The parity symbols are now also serially coded afterwards (e.g. 8b10b) in order to fulfill the requirements for serial transmission (run length, DC balance etc.). This additional subsequent coding of the parity symbols requires an additional encoder in hardware.
   b. Instead of the aforementioned subsequent serial coding of the parity symbols, there are also solutions with feedback of the parity symbols to step 1). With a serial encoder, it is possible to control the DC balance based on the selection of a positive or negative symbol. However, this is associated with a corresponding dead time (depending on the values of serial coding and the FEC encoder). This can, for example, lead to a large deviation in the amount of the temporary DC balancing.
   c. The parity symbols are sent untreated directly to the serial link (e.g. DisplayPort 2.0). However, this is very inaccurate as the parity symbols are generated depending on the input data. Here one relies on the fact that the parity symbols are DC-balanced on average.

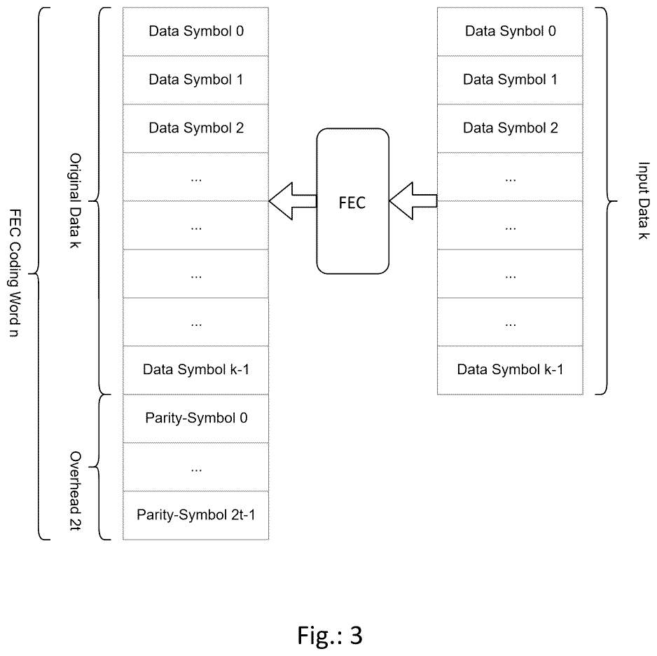

All the methods mentioned (a-c) have the disadvantage that they require a large amount of resources (e.g. two serial encoders) or lead to insufficiently accurate serial coding (e.g. DC balancing, run length, spectrum). In combination with the transmission channel, inaccurate control of the serial coding in particular can lead to the data stream not being reconstructed correctly on the receiver side (CDR samples incorrectly). These effects are mitigated in operation with FEC (as it corrects bit/symbol errors), which unnecessarily deprives the FEC encoding of correction margin for further necessary error correction for errors caused by signal integrity or e.g. external influences with each error caused by poor serial encoding. A Reed Solomon FEC can only correct t symbol errors based on the size of the overhead (2t see FIG. 3) in symbols.

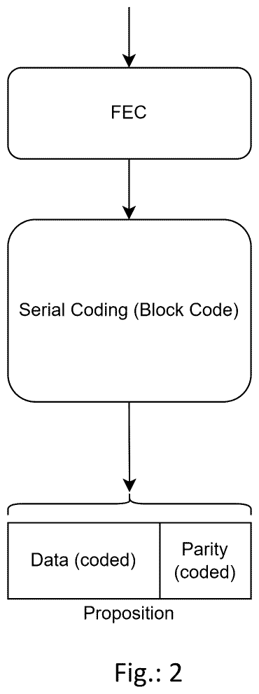

FIG. 2, on the other hand, shows the method according to embodiments of the invention, in which forward error corrections are generated via the user data and these are then also encoded with the user data. The advantage here is that both the user data and the forward error correction are line-coded and therefore errors are robust. This figure also shows that the difference to the prior art is that the forward error correction is generated directly on the user data and not on the line-coded user data. This then makes it possible to transmit all data in line-coded form, which in turn results in increased error robustness.

The method proposed below to improve the above-mentioned problems applies to all conceivable ECC/FEC encodings and is not only applicable to Reed Solomon codes.

The procedure presented changes the sequence of serial coding and FEC:
1. The input data is protected in the first step by means of FEC or several individual FEC units of smaller symbol width (6-12 bits). This also leads to an overall overhead of 2t.
The use of several FEC sub-codings is expressly preferred here, as this has further positive properties (explained below).
2. The respective current FEC output symbol(s) (not to be confused with the entire FEC coding word n) is then coded using block code in such a way that all the desired properties of DC balance, run length, frequency spectrum etc. are maintained.

In the case of multiple FEC coding in step 1.), exactly the same number of block coders is used here. On the receive side, this means that a bit error on the link that destroys a complete data symbol of the serial code results in only a single FEC symbol error.

FIG. 3 shows a prior art flowchart where the input data is line coded and then a forward error correction is generated. This forward error correction is appended to the present right side, as shown at the bottom. This means that the data word is first line-encoded at the top and then a non-line-encoded forward error correction is appended. This now poses a problem, as the forward error correction does not have the desired properties required for robust data transmission. This results in disadvantages because the data is not DC (digital current) balanced, i.e. an advantageous parity is not set. In addition, errors can occur during clock recovery with non-line-coded transmission. In general, line coding is advantageous in that an average value of the analog signals can be measured and then it can be checked which actual signals are above this average value and which are below it. Here it is desirable that the number of analog signals above the mean value, i.e. digital “1”, is equal to the number of analog signals below the mean value, i.e. digital “0”. This means that optimized signal modelling can be carried out. This is not possible in the present FIG. 3, as the forward error correction code is not line coded.

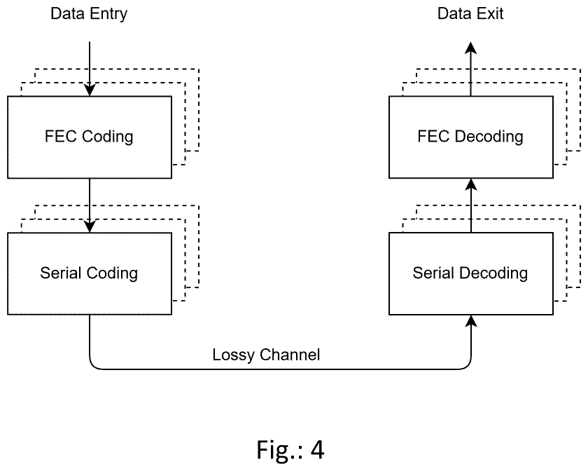

FIG. 4 shows the procedure according to embodiments of the invention and transmission via a lossy channel. Here, each channel is potentially subject to loss and it is particularly advantageous that the forward error coding takes place first at the data input and then the entire serial coding takes place. On the receiver side, the procedure is carried out in reverse and serial decoding is carried out first, whereby the forward error correction is restored in addition to the user data.

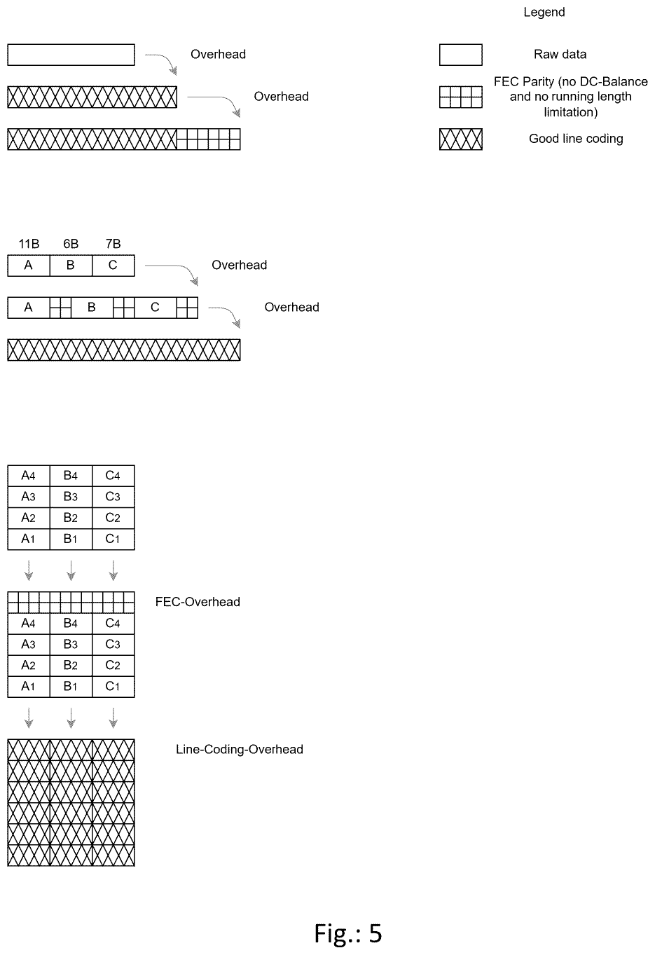

FIG. 5 shows an upper example of a prior art method in which an output data word or a bit sequence is line coded from the first to the second line in a first method step. This results in a code that is longer than the output bit sequence, which is also referred to here as overhead. In a subsequent process step, a forward error correction code is generated from the second line to the third line, which is added to the line coding. As can now be seen, the first part on the left of the data to be transmitted is line-coded and the second part, namely the forward error correction, is not line-coded. This causes problems, as the advantages of line coding have to be dispensed with in the appendix on the right-hand side. This is disadvantageous.

In the embodiment example in the middle of this figure, the source word ABC is again shown at the top. The bit sequence therefore consists of the segments A, B and C. These are 11 bits, 6 bits and 7 bits long in the present case. In accordance with embodiments of the invention, it is not the entire data word, i.e. the entire bit sequence, that is protected in its entirety, i.e. provided with a forward error correction code, but rather the individual segments are protected. This is shown in the second line by the fact that the corresponding forward error correction code is shown after each segment A, B and C. In a subsequent process step, line coding is applied in the third line or the data from the second line is completely line coded, resulting in a line code in the third line. This can now be transmitted and it can be seen that the entire data is line coded and that the forward error correction code is also line coded. The advantages of line coding therefore apply to all data to be transmitted.

In the embodiment example at the bottom of FIG. 5, the method steps according to embodiments of the invention are shown, whereby further sub-steps are possible. The different bit sequences are shown, whereby the user data has now been subdivided into bit sequences of the same length. Thus, the entirety of the user data is divided into four bit sequences, which are all of the same length. These four bit sequences are in turn subdivided into segments of the same length. Figuratively speaking, individual bit sequences are arranged horizontally and these bit sequences are arranged one below the other, so that each line reflects a bit sequence. As can also be seen, the bit sequences are each divided into three segments of equal length. This gives a matrix-like arrangement of the user data in bit sequences per row and segments per column.

Now a line coding is not carried out, as provided for in the prior art, but a partial forward error correction is calculated for each column, i.e. for all segments at the same bit position, in accordance with the subdivision rule as specified in the method step above. As can be seen in the first line of the second rectangle, a partial forward error correction is shown above, which is referred to in its entirety as FEC overhead in this figure. The segmented bit sequences are now available in accordance with the subdivision rule and the partial forward error corrections are available for all segments of the same bit position across all bit sequences.

A segment encoder is now applied to all segments of the same bit position in order to generate segment line codes for all segments per bit position and per bit sequence. In a further or in the same process step, the segment encoder that was also used for the segments is applied to the respective partial forward error correction, resulting in a single line code comprising the segment line codes and the partial forward error correction line codes. As can now be seen below in the present FIG. 5, all data has therefore been line coded and, in particular, the forward error correction FEC has also been line coded. This means that this data can now be transmitted advantageously.

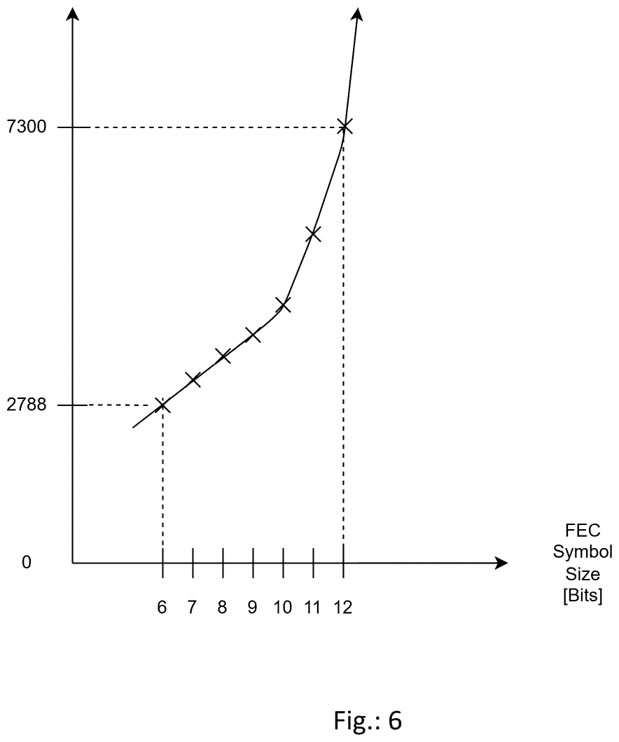

FIG. 6 shows in a diagram on the y-axis the number of gates required when creating a forward error correction code as a function of the bit length to be encoded on the x-axis. As can be seen here, this is an exponential growth and from a bit length of 10-12 bits, the growth of the gates, i.e. the number of gates required for the forward error corrections, increases at an above-average rate. According to embodiments of the invention, it is therefore particularly advantageous to carry out the forward error correction for each segment, as this avoids having to take into account the entire data word, i.e. the entire bit length. If the entire bit length had to be taken into account for the forward error correction, the bit length would typically be beyond the critical 12 bits. The gates required in the forward error correction encoder would increase in an unfavorable manner. This therefore illustrates the advantageous technical effect of the present invention, which first forms segments via the bit sequence and then calculates the forward error correction on the segments.

At this point, reference is again made to the subdivision rule according to FIG. 5, which provides that a segment can have 11 bits, 6 bits or 7 bits.

By using several FEC encoders/decoders with a smaller FEC symbol size, both the number of required gates is reduced and the maximum operating frequency for a given process node Fₘₐₓ is increased (shorter carry chains, more parallelism).

FIG. 6 shows the relationship between the FEC symbol size in bits and the required implementation. This refers to a hardware implementation of a Reed Solomon FEC. The number of gates is normalized (to 12 bit symbol size) and can therefore be compared directly. The exponentially pronounced relationship between symbol size in bits and the implementation in gates can be seen in the graph.

The same symbol widths do not always have to be used for the respective small FEC sub-encoders. Large serial encodings can also consist of several different sub-encoders (the simplest example is 8b10b which can be constructed from 3b4b and 5b6b), as proposed for use with FEC. In the case of embodiments of the present invention or ADXpress (registered trademark), this is achieved by a total of 11 encoders with four basic types: 6b8b, 7b8b, 11b12b and 11b13b. The FEC symbol width used for the respective sub-coding is determined by the data word width of the respective serial encoder. For example, an FEC with a symbol width of 6 bits is used for 6b8b.

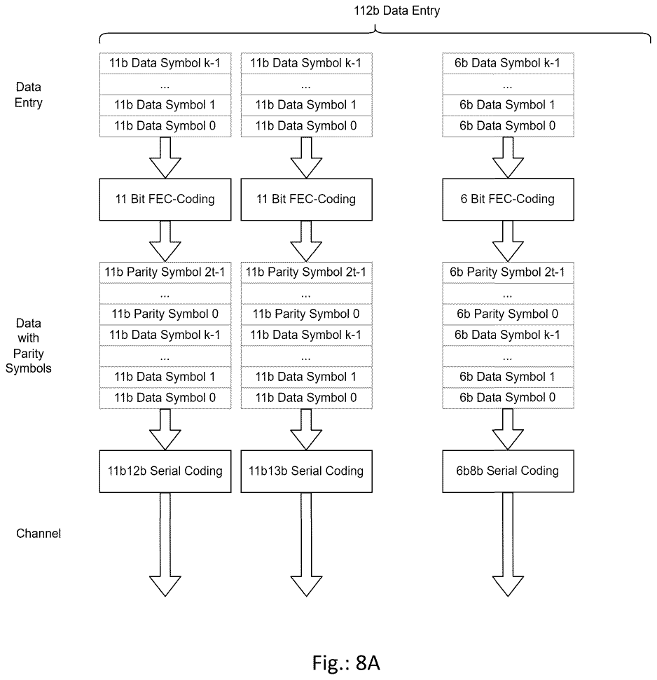

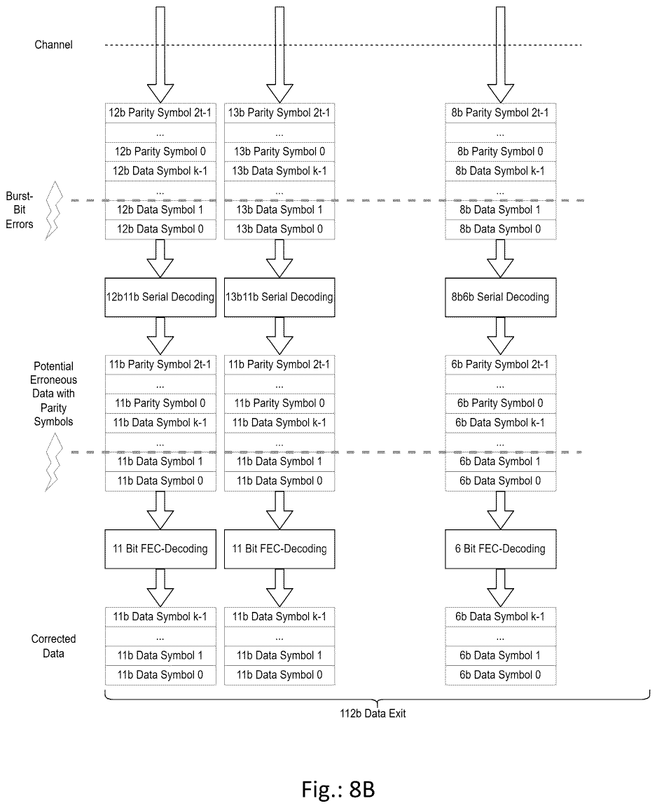

The complete structure for the transmitter data path of embodiments of the present invention or ADXpress (registered trademark) is shown according to one aspect in FIG. 8A. The data path in the receiver has a corresponding inverse structure (see also FIG. 8B).

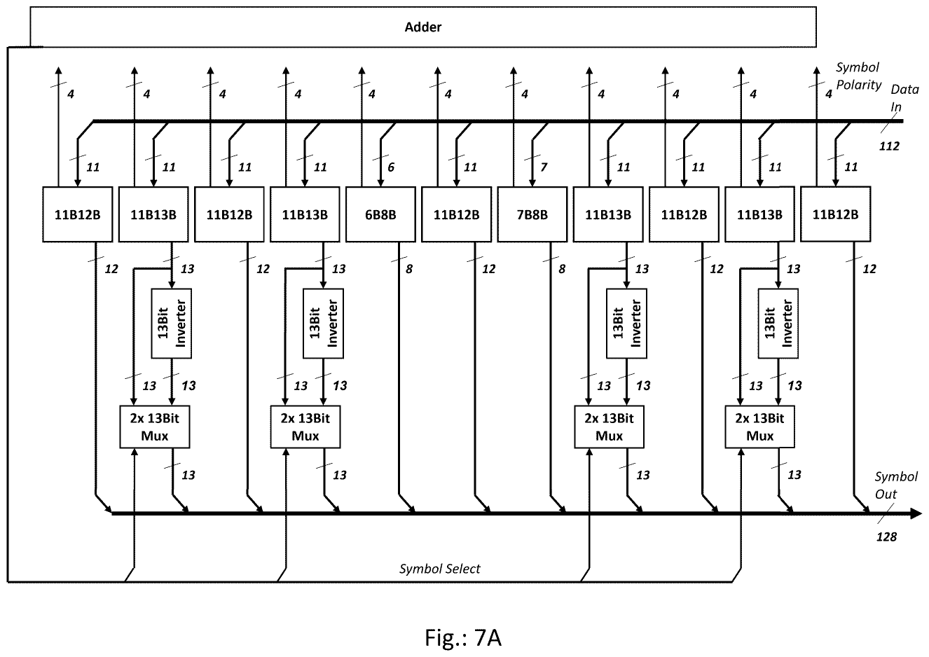

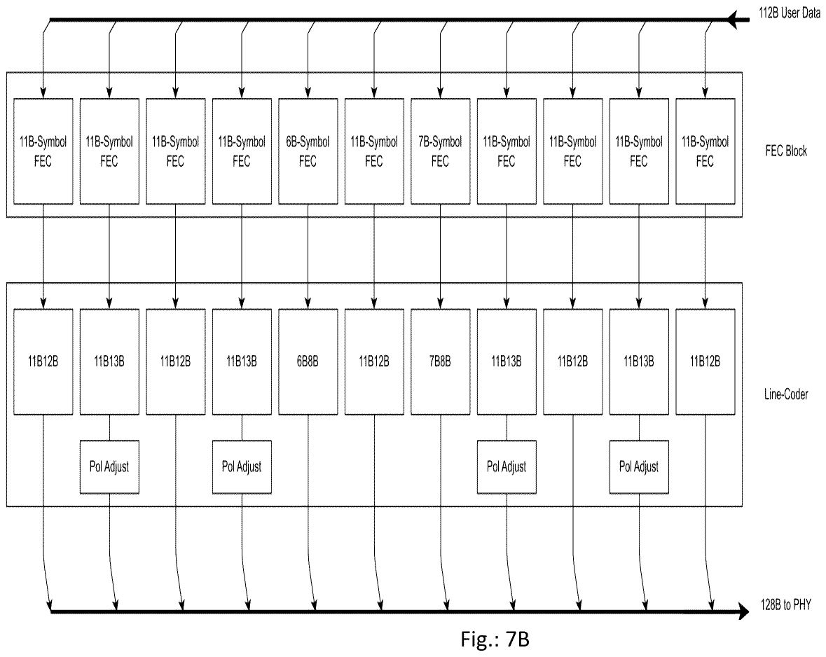

FIG. 7A shows a line coding or a line coding device with several line coding units which, for example, map 11 bits to 12 bits, map 11 bits to 13 bits, or map 11 bits to 12 bits. This corresponds to the right-to-left sequence in the present FIG. 7 and illustrates that the input data word, i.e. the bit sequence above, is divided into individual segments and then the individual segments are line coded. The calculation of the forward error correction is not yet taken into account in the present FIG. 7A, so that the system arrangement according to FIG. 7A can serve as the output system arrangement for the present invention.

FIG. 7A shows above the arbitrary bit sequence of 112 bits, which is segmented into 11, 6 or 7 bits. The coding units are then addressed in parallel, which convert the bits into sub-symbols in such a way that they are optimized in terms of disparity. For example, 11 bits are coded after 12 bits or 11 bits after 13 bits.

In this FIG. 7A, a coding unit from the second subset is shown on the far left-hand side in the middle, which is labeled 11B12B. This provides a partial symbol with any sign, i.e. with any disparity. To compensate for this disparity, the coded unit 11B13B is connected downstream in parallel with respect to the bit sequence. This means that a data stream is formed which converts the most significant bits of twice 11 into two sub-symbols, namely once the 11-bit data segment is formed by 11B12B into a 12-bit sub-symbol with any sign, i.e. disparity, and once the data segment is encoded from 11 bits into 13 bits by means of the encoding unit 11B13B. In the figure below the coding units, the second coding unit from the left 11B13B is a coding unit of the first subset. This has an inverter and a multiplexer. The first 13 bits are therefore available as a data stream, which is split in such a way that it is inverted once with regard to the sign, i.e. the disparity, and once remains unchanged. It is shown below that the positive or negative, i.e. the original or inverted data stream that compensates for the sign from the leftmost coding unit is used under disparity feedback. There are therefore two data streams at the first multiplexer on the left, each of which represents the partial symbol, one with a conventional sign, i.e. as output from the 11-bit 13-bit coding unit, and one with an inverted sign or inverted disparity.

Based on the feedback from the unit at the top, the disparity resulting from the leftmost encoder 11B12B is determined and the multiplexer, at the bottom left, compensates or minimizes the disparity of the partial symbol of the leftmost encoder 11B12B. This is carried out in parallel in such a way that the coding units from the second subset are followed by coding units from the first subset, which minimize or eliminate the disparity. Finally, the total symbol is output at the bottom right. This total symbol has 128 bits and is composed of the sub-symbols as they are inserted into the bold line below using the slanted arrows. Thus, the sub-symbols which are optimized or minimized with regard to disparity are present on this output line and these sub-symbols form the entire symbol which can then be output and transmitted.

According to one aspect of the present invention, the invention encodes a 112-bit wide data word, with any disparity (disparity max: 112) and any run length (run length max: 112), onto a 128-bit wide symbol. The overhead resulting from the coding is therefore 14.2%.

The maximum run length occurring in the symbol, as well as with any sequencing of any symbols, is 8 equal bits.

The maximum disparity in the long average is 0 and the disparity in a symbol is less than 9.

The complexity of the logic is minimal, comparable with 10 8B/10B encoders (with the known disadvantage of the large overhead).

This is achieved by the use, or parallel use, of several “small” encoders that are optimally matched to each other in terms of their disparity and run length characteristics.

The 11B12B, 7B8B and 6B8B encoders generate all symbols with a guaranteed maximum run length of 6, even if the (partial) symbols are sequenced in any order.

According to one aspect of the present invention, the encoder (11B13B) generates symbols with a guaranteed maximum run length of 7 or at the beginning or end of the symbol of 5. Due to the sequencing (FIG. 2) of (11B13B) with the other encoders, a maximum run length of 8 can thus be generated in the symbol.

See properties of the encoder as follows:
11B13B: 11 bits of data are mapped to 2048 symbols with 13 bits. The symbols can be transmitted in inverted or non-inverted form.
   Disparity:
   +3 . . . +9 or controllable −3 . . . −9
   Run length in the word: 7
   Run length at the edge: 5.
11B13B: 11-bit data is mapped to 2048 symbols with 13 bits. The symbols can be transmitted in inverted or non-inverted form.
   Disparity: +3 . . . +9 or controllable −3 . . . 9
   Run length in the word: 7
   Run length at the edge: 5
11B12B: 11-bit data is mapped to 2048 symbols with 12 bits. The symbols are only transmitted non-inverted.
   Disparity: −2, −1, 0, 1, 2
   Run length in the word: 6
   Run length at the edge: 3
7B8B: 7-bit data is mapped to 128 symbols with 8 bits. The symbols are only transmitted non-inverted.
   Disparity: −2, −1, 0, 1, 2
   Run length in the word: 6
   Run length at the edge: 3
6B8B: 6-bit data is mapped to 64 symbols with 8 bits. The symbols are only transmitted non-inverted.
   Disparity: 0
   Run length in the word: 6
   Run length at the edge: 3

With the four 11B13B encoders, a disparity of at least +−12 can be controllably generated in order to compensate for the non-controllable disparity of a maximum of +−12 (6×+−2) of the 11B12B and 7B8B encoders, so that a balanced disparity can be reliably achieved irrespective of the data to be transmitted.

In order to further reduce the complexity of the hardware, four small encoders (11B13B) are used according to one aspect of the present invention, the disparity of which can be controlled in terms of sign (+−).

According to one aspect of the present invention, the symbol disparity is controlled in such a way that each encoder calculates the parity of “its” sub-symbol. This is done with little effort, since the subsymbol has only a few bits.

With four of the eleven encoders, the sign of the disparity of the subsymbol can be actively controlled by inverting the generated subsymbol. For this purpose, the encoders (11B13B) have the special feature that their symbols generate a symbol with positive disparity (+3 . . . +9) for all input data. By inverting the partial symbol, a symbol with negative disparity (−3 . . . −9) is obtained.

In this way, the disparity (−2,−1,0,1,2) of the partial symbols of the other encoders (11B12B and 7B8B) can be compensated. The encoder 6B8B generates symbols whose disparity is always 0. Then all (partial) parities of the encoders (11B12B and 7B8B) are added together and the result controls the decision as to how many inverted and non-inverted symbols of the encoder (11B13B) are used.

The minimum (smallest) disparity of the encoder 11B13B is +−3. So in total, a disparity of +−12 (4*+−3) per symbol can be safely compensated with these four encoders.

Furthermore, five (11B12B) encoders and one (7B8B) encoder are used whose maximum disparity is +−2. So in the extreme case, these six encoders generate a disparity of exactly +−12 (2*+−6). This can be safely compensated by the 11B13B encoders.

According to one aspect of the present invention, the method achieves the same quality as an 8B10B code but with half the overhead (loss due to encoding).

The implementation of the encoding and decoding hardware requires minimal resources (logic) due to the use of multiple small encoders instead of one large one.

Encoding can typically be done completely in one cycle of the parallel data path (no pipelining necessary).

The control of the disparity of the 128 bit symbol can be realized with (very) little logic and can be realized completely within one clock of the data path (slow), instead of calculating the disparity by counting the one and zero bits in the serial data stream with the very fast serial clock.

Due to the deterministic disparity and run length, further scrambling is not necessary and therefore fast synchronization to the data stream on the receiver side is possible (no scrambler synchronization required).

Among other things, this is very useful for power save modes in which the link can be switched off to save energy and switched on again when required. For this, fast synchronization between transmitter and receiver is a must.

According to one aspect of the present invention, the invention encodes a 112-bit wide data word, with any disparity (disparity max: 112) and any run length (run length max: 112), onto a 128-bit wide symbol. The overhead resulting from the coding is therefore 14.2%.

The maximum run length occurring in the symbol, as well as with any sequencing of any symbols, is 8 equal bits.

The maximum disparity in the long average is 0 and the disparity in a symbol is less than 9.

The complexity of the logic is minimal, comparable to 10 8B/10B encoders (with the known disadvantage of the large overhead).

This is achieved by the use, or parallel use, of several “small” encoders that are optimally matched to each other in terms of their disparity and run length characteristics.

The 11B12B, 7B8B and 6B8B encoders generate all symbols with a guaranteed maximum run length of 6, even if the (partial) symbols are sequenced in any order.

According to one aspect of the present invention, the encoder (11B13B) generates symbols with a guaranteed maximum run length of 7 or at the beginning or end of the symbol of 5. Due to the sequencing (FIG. 2) of (11B13B) with the other encoders, a maximum run length of 8 can thus be generated in the symbol.

See properties of the encoder as follows:

To further reduce the complexity of the hardware, four small encoders (11B13B) are used whose disparity can be controlled in terms of sign (+−).

According to one aspect of the present invention, the symbol disparity is controlled in such a way that each encoder calculates the parity of “its” sub-symbol. This is done with little effort, since the subsymbol has only a few bits.

With four of the eleven encoders, the sign of the disparity of the subsymbol can be actively controlled by inverting the generated subsymbol. For this purpose, the encoders (11B13B) have the special feature that their symbols generate a symbol with positive disparity (+3 . . . +9) for all input data. By inverting the partial symbol, a symbol with negative disparity (−3 . . . −9) is obtained.

In this way, the disparity (−2, −1,0,1,2) of the partial symbols of the other encoders (11B12B and 7B8B) can be compensated. The encoder 6B8B generates symbols whose disparity is always 0. Then all (partial) parities of the encoders (11B12B and 7B8B) are added together and the result controls the decision as to how many inverted and non-inverted symbols of the encoder (11B13B) are used.

The minimum (smallest) disparity of the encoder 11B13B is +−3. So in total, a disparity of +−12 (4*+−3) per symbol can be safely compensated with these four encoders.

Furthermore, five (11B12B) encoders and one (7B8B) encoder are used whose maximum disparity is +−2. So in the extreme case, these six encoders generate a disparity of exactly +−12 (2*+−6). This can be safely compensated by the 11B13B encoders.

The process achieves the same quality as an 8B10B code but with half the overhead (loss due to coding).

The implementation of the encoding and decoding hardware requires minimal resources (logic) due to the use of multiple small encoders instead of one large one.

Encoding can typically be done completely in one cycle of the parallel data path (no pipelining necessary).

The control of the disparity of the 128 bit symbol can be realized with (very) little logic, and can be realized completely within one clock cycle of the data path (slow), instead of calculating the disparity by counting the one and zero bits in the serial data stream with the very fast serial clock.

Due to the deterministic disparity and run length, further scrambling is not necessary and therefore fast synchronization to the data stream is possible on the receiver side (no scrambler synchronization required).

Among other things, this is very useful for power save modes in which the link can be switched off to save energy and switched on again when required. For this, fast synchronization between transmitter and receiver is a must.

FIG. 7B now shows the adapted system arrangement from FIG. 7A, with the corresponding partial forward error correction encoders now drawn in. These are referred to here as FEC blocks. This figure therefore shows that segments are first formed from the bit sequences, which corresponds to the upper arrows pointing downwards from the user data. This is where the partial forward error corrections are generated and then fed into the coding units, as already shown in FIG. 7A. The line coding units are referred to here as line coders and encode both the segments of the bit sequences and the partial forward error corrections. The parity can also be adjusted in optional process steps. The line-encoded data is then output at the bottom and transmitted to the right via a potentially error-prone communication channel to a receiver, not shown here.

FIG. 8A shows the method according to embodiments of the invention for improving forward error correction and shows in particular the process steps that are carried out on the transmitter side. The arrows at the bottom of FIG. 8A correspond to the arrow at the top of the following FIG. 8B. The data is therefore entered as shown in FIG. 8A and then the partial forward error correction is calculated. As can be seen above, all segments are of the same bit length. This means that the first column comprises 11 bits, the second column comprises 11 bits and the last column comprises 6 bits.

A partial forward error correction is now generated for all segments of the same bit sequence, which has the same bit length as the corresponding segments. This results in the data with a parity symbol. In a final process step, serial line coding takes place, which maps 11 bits to 12 bits or 11 bits to 13 bits or 6 bits to 8 bits, for example. This data can now be transmitted via the potentially interference-prone channel. This results in a transmission as shown in FIG. 8A below or in FIG. 8B above.

FIG. 8B shows the procedure on the receiver side and corresponds inversely to the procedure in FIG. 8A. As is also shown in the present FIG. 8B, it is recognized that bit errors may be present, but these can be handled particularly advantageously at segment level. The bit errors therefore do not occur in the entire bit sequence, but only on individual segments and can therefore be treated advantageously. This leads to the corrected data as shown in FIG. 8B below and the 112 bits are thus recovered, as they served as the output in FIG. 8A.

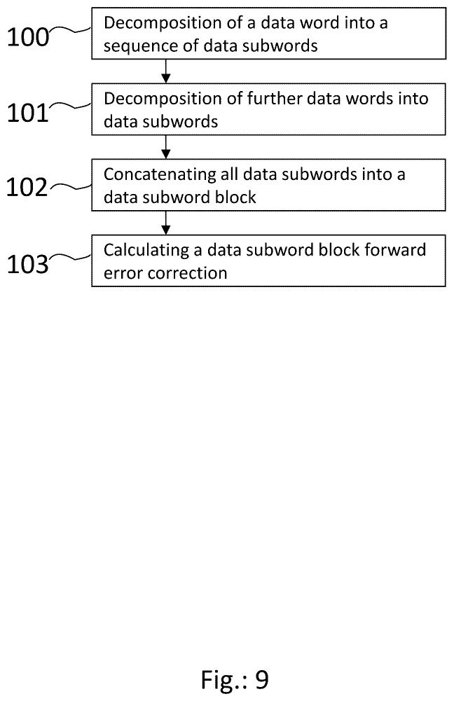

FIG. 9 shows in a flow chart a method for calculating a forward error correction with a reduced number of gates in FEC encoders, comprising a decomposition 100 of a data word into a sequence of data subwords according to a provided data structure; decomposing 101 further data words into data subwords of the data structure, wherein a position index is assigned to each position of the data subwords within the sequence; concatenating 102 all data subwords of the same position index into a data subword block; and calculating 103 a data subword block forward error correction over each data subword block, in such a way that its data subwords are treated together, whereby a line code segment is generated for each data subword block and/or each data subword block forward error correction.

In addition, all segment line codes and all partial forward error correction line codes are transferred: In this last step, all generated segment line codes and partial forward error correction line codes are transmitted. These transmitted codes contain the error detection and correction information for the corresponding segments and partial forward error corrections. The method described enables improved forward error correction during serial coding and data transmission in the vehicle. By dividing the user data into segments and applying specific coding procedures to these segments, effective error detection and correction is achieved at segment level.

By iteratively creating a partial forward error correction for all segments of the same bit position and applying a segment encoder to each segment, targeted error correction for the transmitted data is made possible. The partial forward error correction line codes contain the necessary information to detect and correct errors, while the segment line codes represent the structure and content of the segments and also contribute to error detection and correction.

By transmitting all generated segment line codes and partial forward error correction line codes, the receiver can analyze the received data accordingly and detect and correct errors to ensure reliable and accurate transmission of the user data in the vehicle.

The method described thus provides improved forward error correction, which is particularly important in demanding environments such as vehicles, where interference and signal loss can occur. It helps to ensure reliable and high-quality data transmission, which is of great importance for various applications in the vehicle sector, such as autonomous driving, vehicle safety systems and infotainment applications.

Embodiments of the invention make it possible to maintain all desired characteristics and requirements for serial coding at all times while operating an FEC efficiently. By deliberately positioning the serial encoder after the FEC units, the physical behavior on the link is always deterministically controllable (not the case with scrambler as serial encoding).

In addition, the selection of the FEC symbol size based on the data word size of the respective serial sub-encoder always ensures that bit errors always propagate to a minimum (a defective line code symbol then only generates a defective FEC symbol).

Furthermore, the use of several FEC sub-encoders creates a very efficient type of so-called interleaving. This is possible without time-consuming manual interleaving of the symbols, which would always require data to be held (more latency and buffer). This also makes it possible to correct burst errors, e.g. 112/128 bit errors at once.

It can only be seen from the schematic structure in FIGS. 7A, 7B and 8A, 8B that this is the case: in this case, 128 bit errors lead to only one symbol error of the respective FEC sub-encoder. With classic single FEC coding, a burst error of the same length (128 erroneous bits in succession) would generate several symbol errors in succession. Depending on the encoding selected, this can lead to the FEC word (all symbols of an FEC cycle) no longer being able to be decoded (this also makes correction impossible). This is normally achieved by interleaving the symbols of an FEC cycle with those of one or more other FEC cycles. However, this is only possible by using buffers on the transmitting and receiving side in order to be able to interleave the data in the case of the transmitter and to bring this back into the original continuous FEC symbol data stream of the individual FEC cycles in the receiver by means of the inverse operation. By using several small FEC encoders, interleaving and thus also the provision of the buffers required for interleaving becomes superfluous (but only to a certain extent, a burst error of more than the 128 bits in a row mentioned in the example leads to more than one symbol being damaged per individual FEC).

How many symbols a respective FEC sub-encoder can repair (t) depends on the overhead 2t see FIG. 2. This must be selected accordingly for the desired application. The case shown in FIG. 8A with one symbol error per FEC sub-encoder is already reached at t=1 (i.e. two parity symbols overhead). It should also be noted that the burst error may/can also occur without any restrictions in the area of the parity symbols.

What is claimed is:

1. A method for calculating a forward error correction with a reduced number of
gates in FEC coders, comprising:
a decomposition (100) of a data word into a sequence of data subwords according to a provided data structure;
decomposition (101) of further data words into data subwords of the data structure, wherein each position of the data subwords within the sequence is assigned a position index;
concatenating (102) all data subwords of the same position index into a data subword block; and
calculating (103) a data subword block forward error correction over each data subword block, in such a way that its data subwords are treated together, whereby a line code segment is generated for each data subword block and/or each data subword block forward error correction.

2. The method of claim 1, wherein a forward error correction for a data block is composed of several partial forward error corrections of the data subword blocks.

3. The method of claim 1, wherein the data structure is read out and an FEC partial encoder is selected in each case as a function of the respective bit lengths of the data subwords.

4. The method of claim 1, wherein the number of gates of the FEC sub-encoders is selected as a function of a bit length of the data sub-words.

5. The method of claim 1, wherein each data word has 112 bits.

6. The method of claim 1, wherein the bit length of the data subword block forward error correction is selected in such a way that it corresponds to the bit length of the data subwords.

7. The method of claim 1, wherein the data subword block forward error correction and the data subword block on the basis of which the data subword block forward error correction is calculated are line-encoded by means of the same line encoder.

8. The method of claim 1, wherein the data structure is selected as a function of the bit length of the data words.

9. The method of claim 1, wherein serial line coding takes place after the calculation of the data subword block forward error correction.

10. The method of claim 1, wherein the method steps are executed in a virtualized manner and information about the underlying encoders and/or gates is generated.

11. A system arrangement for calculating a forward error correction with a reduced number of gates for FEC coders, comprising:
a decomposition unit arranged to decompose (100) a data word into a sequence of data subwords according to a provided data structure;
a further decomposition unit set up for decomposing (101) further data words into data subwords of the data structure, wherein a position index is assigned to each position of the data subwords within the sequence;
a grouping unit set up for concatenating (102) all data subwords of the same position index into a respective data subword block; and
a calculating unit adapted to calculate (103) a data subword block forward error correction over each data subword block, respectively, in such a way that its data subwords are treated together, whereby a line code segment is generated for each data subword block and/or each data subword block forward error correction.

12. A computer program product comprising instructions fixed in a non-transitory medium which, when the program is executed by at least one computer, cause the computer to perform the steps of the method of claim 1.

13. A non-transitory computer readable storage medium comprising instructions which, when executed by at least one computer, cause the computer to perform the steps of the method of claim 1.
